(19) United States
(12) Patent Application Publication
(10) Pub. No.: US 2026/0229152 A1
(43) Pub. Date: Aug. 6, 2026

(54) SYSTEMS AND METHODS FOR A VISUAL DISPLAY WITH INTERCHANGEABLE PANELS

(71) Applicant: World of Illumination LLC, Phoenix, AZ (US)

(72) Inventor: Yakir Urman, Phoenix, AZ (US)

(73) Assignee: World of Illumination LLC, Phoenix, AZ (US)

(21) Appl. No.: 19/465,945

(22) Filed: Jan. 30, 2026

Related U.S. Application Data
(60) Provisional application No. 63/752,239, filed on Jan. 31, 2025.

(51) Int. Cl. G09F 9/302; G09F 9/33; G09F 15/00

(52) U.S. Cl. CPC G09F 9/3026; G09F 15/0018; G09F 15/0075; G09F 9/33

(57) ABSTRACT

A visual display arrangement includes a support structure, a mounting structure configured to be removably coupled to the support structure, and a display panel configured to be removably coupled to the mounting structure. The support structure can include one or more upright frame members. The mounting structure can include one or more horizontal support members configured to be mounted to the one or more upright frame members. The display panel can be mounted to the support structure via a plurality of fasteners extending horizontally from the one or more horizontal support members. The display panel includes a plurality of apertures configured to receive the plurality of fasteners. In a lighted panel arrangement, the display panel can include a second plurality of apertures configured to receive a plurality of lights elements. The display panel can be interchangeable with other display panels utilizing a common mounting structure/support structure.

### CROSS-REFERENCE TO RELATED APPLICATIONS

This application is a nonprovisional of, and claims priority to and the benefit of, U.S. Provisional Patent Application No. 63/752,239, filed Jan. 31, 2025 and entitled “SYSTEMS AND METHODS FOR A VISUAL DISPLAY WITH INTERCHANGEABLE PANELS,” which is hereby incorporated by reference herein.

### FIELD

The present disclosure relates generally to a visual display system, and, more specifically, to systems and methods for displaying outdoor/indoor advertising and decorative displays.

### BACKGROUND

Signs are generally any kind of visual graphics created to display information to a particular audience. Signs vary in form and size based on location and intent, from more expansive banners, billboards, and murals, to smaller street signs, street name signs, sandwich boards, and lawn signs. Some signs may also use digital or electronic displays. Signs convey information designed to assist, to convey information, to advertise, to entertain, and/or as decoration.

Outdoor/indoor signage systems face a number of challenges. The installation of signage systems can be very complicated and time-consuming. Furthermore, the adaption of signage system messages so that the message is appropriate for the present situation can involve significant complications.

Many people put up electronic displays to celebrate events (holidays, seasons, special occasions, etc.). These signs are removed after the event and stored until the next event. Another display is used for the next event. This is time consuming, requires usage of a lot of space and extra effort to remove one display for another display, etc.

In light of the foregoing, there is a need for a device that can display various signs (e.g., for different holiday celebrations, special occasions, and/or for different seasons).

### SUMMARY

In accordance with various examples, a visual display arrangement includes a support structure including a first upright frame member, a mounting structure configured to be mounted to the support structure and including a first horizontal support member configured to be mounted to the first upright frame member, a plurality of fasteners configured to extend horizontally from the first horizontal support member, and a display panel configured to be removably mounted to the support structure via the plurality of fasteners. The display panel includes a plurality of fastener apertures configured to receive the plurality of fasteners for removably coupling the display panel to the support structure.

In various examples, the support structure further includes a second upright frame member, and the first horizontal support member extends between and to the first upright frame member and the second upright frame member.

In various examples, the support structure is formed as one of a tower or an arch.

In various examples, the first horizontal support member includes a plurality of apertures each configured to receive a respective one of the plurality of fasteners.

In various examples, the mounting structure further includes a second horizontal support member, the plurality of fasteners includes a first fastener configured to extend from the first horizontal support member and a second fastener configured to extend from the second horizontal support member, and the display panel is configured to extend between and to the first fastener and the second fastener so as to be supported by the first horizontal support member and the second horizontal support member.

In various examples, the plurality of fasteners includes a threaded rod, a first pair of nut fasteners configured to secure the threaded rod to the first horizontal support member, and a second pair of nut fasteners configured to secure the display panel to the threaded rod.

In various examples, the visual display arrangement further includes a plurality of lights, wherein the display panel comprises a plurality of light apertures configured to receive the plurality of lights.

In various examples, the visual display arrangement further includes a controller configured to be disposed adjacent the support structure and configured to operate the plurality of lights by adjusting at least one of a color or a brightness of each light of the plurality of lights, and the controller includes a storage configured to store a light display file for operating the plurality of lights.

In various examples, a rear surface of the display panel includes a label identifying (i) a layout of a location of a sub-panel of the display panel with respect to other sub-panels of the display panel, (ii) a layout of a location for installing a plurality of lights to the display panel, and/or (iii) a layout of a location for installing the first horizontal support member to the display panel.

In various examples, the display panel includes a plurality of sub-panels each individually removable from the support structure.

In various examples, the visual display arrangement further includes a rear cover panel configured to be disposed between a rear surface of the display panel and the first horizontal support member so as to cover the rear surface.

In various examples, in an installed position, the display panel is configured to be spaced apart from the first horizontal support member so that the rear cover panel can be moved over at least one fastener of the plurality of fasteners, wherein the at least one fastener extends through a slot disposed in the rear cover panel.

In various examples, the support structure further includes a second upright frame member. In various examples, the support structure further includes a first horizontal frame member configured to be coupled between a first end of the first upright frame member and a first end of the second upright frame member, and the first horizontal support member is configured to be coupled to the first upright frame member at a location spaced apart from the first end of the first upright frame member.

In various examples, the visual display arrangement further includes a bracket for removably coupling the first horizontal support member to the first upright frame member.

In another example, the subject matter may be embodied in a visual display arrangement including a support structure, a plurality of lights, and a display panel configured to be mounted to the support structure. The display panel includes a front surface having a design and a rear surface, the display panel includes a first plurality of apertures configured to receive a plurality of fasteners from the rear surface for removably coupling the display panel to the support structure. The display panel includes a second plurality of apertures each configured for receiving a respective one of the plurality of lights from the rear surface of the display panel, and the design and the plurality of lights are configured to be viewable from the front surface of the display panel.

In various examples, the visual display arrangement further includes a mounting structure coupled between the support structure and the plurality of fasteners.

In various examples, the display panel is spaced apart from the mounting structure via the plurality of fasteners.

In various examples, the mounting structure is formed as a u-shaped channel.

In various examples, the visual display arrangement further includes a rear cover panel including an elongated slot configured to receive the plurality of fasteners whereby the rear cover panel is secured to the support structure.

In various examples, the support structure includes a first arch including a first upright support, a second upright support spaced apart from the first upright support, and a first horizontal support extending between and to the first upright support and the second upright support. In various examples, the support structure includes a second arch including a third upright support, a fourth upright support spaced apart from the third upright support, and a second horizontal support extending between and to the third upright support and the fourth upright support. In various examples, the support structure includes at least one horizontal support extending between and to the first arch and the second arch.

In another example, the subject matter may be embodied in a visual display arrangement, comprising a first arch structure and a second arch structure. The first arch structure can have a first plurality of attachment features disposed along the first arch structure. The second arch structure can be configured to be spaced apart from the first arch structure. The second arch structure can have a second plurality of attachment features disposed along the second arch structure. The visual display arrangement can further comprise a first longitudinal support structure configured to be coupled at a first end of the first arch structure and a first end of the second arch structure. The visual display arrangement can further comprise a second longitudinal support structure configured to be coupled at a first end of the first arch structure and a first end of the second arch structure. The visual display arrangement can further comprise a third longitudinal support structure configured to be coupled between the first arch structure and the second arch structure and spaced apart from the first longitudinal support structure and the second longitudinal support structure. The visual display arrangement can further comprise a first bracket having a first portion configured to be inserted into the first end of the first arch structure and a second portion configured to be inserted into a first end of the first longitudinal support structure. The first arch structure, the second arch structure, the first longitudinal support structure, the second longitudinal support structure, and the first bracket can be coupled together to form a tunnel.

In various examples, the visual display arrangement further comprises a plurality of display features configured to be coupled along the first arch structure via the first plurality of attachment features and along the second arch structure via the second plurality of attachment features.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be example in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1 illustrates a block diagram of a visual display system, in accordance with various examples.

FIG. 2 illustrates a front view of a visual display system, in accordance with various examples.

FIG. 3A, FIG. 3B, and FIG. 3C illustrate various example display panels (also referred to as “skins”) for a visual display system, in accordance with various examples.

FIG. 4A illustrates a rear view of a lighted display panel with a mounting structure installed thereon, in accordance with various examples.

FIG. 4B illustrates an enlarged view of a portion of the lighted display panel of FIG. 4A, in accordance with various examples.

FIG. 4C illustrates a section view of a portion of the lighted display panel of FIG. 4B, in accordance with various examples.

FIG. 5 illustrates a perspective view of a rear portion of a visual display system with a mounting structure coupled to a support structure via a plurality of brackets, in accordance with various examples.

FIG. 6 illustrates a perspective view of a visual display system with sub-panels of the display panel being replaced, in accordance with various examples.

FIG. 7 illustrates a perspective view of a visual display system with a rear cover panel in an installed position, in accordance with various examples.

FIG. 8A illustrates a rear view of a rear cover panel being moved to an installed position, in accordance with various examples.

FIG. 8B illustrates a section view of the rear cover panel in an installed position, in accordance with various examples.

FIG. 9A illustrates a front isometric view of a visual display system, in accordance with various examples.

FIG. 9B illustrates a rear isometric view of the visual display system of FIG. 9A, in accordance with various examples.

FIG. 9C illustrates a rear view of the visual display system of FIG. 9A, in accordance with various examples.

FIG. 9D illustrates a side view of the visual display system of FIG. 9A, in accordance with various examples.

FIG. 9E illustrates a top view of the visual display system of FIG. 9A, in accordance with various examples.

FIG. 9F illustrates a front view of the visual display system of FIG. 9A, in accordance with various examples.

FIG. 10A, FIG. 10B, and FIG. 10C illustrate left perspective, side, and right perspective views, respectively, of hardware for mounting a display panel to a mounting structure, in accordance with various examples.

FIG. 11A, FIG. 11B, FIG. 11C, and FIG. 11D illustrate front perspective, rear perspective, top, and side views, respectively, of a display panel mounted to a mounting structure via a fastener in a first configuration, in accordance with various examples.

FIG. 12A, FIG. 12B, FIG. 12C, and FIG. 12D illustrate front perspective, rear perspective, top, and side views, respectively, of a display panel mounted to a mounting structure via a fastener in a second configuration, in accordance with various examples.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of various examples herein makes reference to the accompanying drawings, which show various examples by way of illustration. While these various examples are described in sufficient detail to enable those skilled in the art to practice the disclosure, it should be understood that other examples may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural examples, and any reference to more than one component or step may include a singular example or step. Also, any reference to attached, fixed, connected, or the like may include permanent, removable, temporary, partial, full, and/or any other possible attachment option. Additionally, any reference to without contact (or similar phrases) may also include reduced contact or minimal contact. Cross hatching lines may be used throughout the figures to denote different parts but not necessarily to denote the same or different materials.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The present disclosure provides a visual display system that generally includes a support structure (i.e., the “bones”) and a display panel (i.e., the “skin”). In various aspects, for example for lighted display panels, the visual display system can further include a control unit (i.e., the “brain”). A mounting structure is coupled between the support structure and the display panel whereby the display panel is mounted to the support structure. The mounting structure can include a plurality of threaded fasteners that fit into respective holes in the display panel for easily mounting and unmounting the display panel to/from the mounting structure. In various aspects the display panel is subdivided into sub-panels to further enhance ease of installation/removal of the display panel. The visual display system is configured so that installation of the display panel is as simple as placing the display panel over the threaded fasteners and subsequently installing threaded nuts to the threaded fasteners to secure the display panel in place.

The control unit can store light display files (i.e., program instructions) for operating a lighted display. Different light display files can be stored on the control unit depending on the skin that is being used. The support structure and associated mounting structure are configured as a “universal” structure that can be used for various interchangeable display panels. In this regard, a user can utilize the same support structure and mounting structure for a variety of display panels, enhancing ease of installation and increasing value to the user. The visual display system can display various signs for different purposes (e.g., holiday celebrations, special events, and/or for different seasons, etc.).

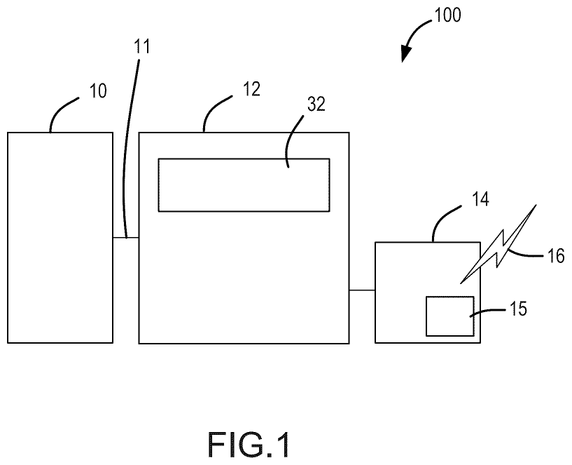

FIG. 1 is a block diagram of a visual display system 100, in accordance with various aspects. The visual display system 100 generally includes a support structure 10, a mounting structure 11, and a display panel 12. The display panel 12 can be mounted to the support structure 10 via the mounting structure 11, for example using fasteners as described herein in further detail. The support structure 10 can be configured to rest on the ground or floor such that the display panel 12 is held up off of the ground and supported by the support structure 10; though it is contemplated that the display panel 12 could rest, at least partially, on the ground and the support structure 10 can assist in securing the display panel 12 in an upright position. The display panel 12 can be a single panel or can be made of a plurality of sub-panels. The sub-panels can be configured to be arranged to appear as a single panel and/or to form one or more decorative designs.

In various aspects, the display panel 12 can include or be coupled to a plurality of decorative display lights 32 (e.g., light bulbs, LEDs, etc.). The visual display system 100 can include a control unit 14 for controlling the display lights 32. In various aspects, the control unit 14 includes one or more controllers (e.g., processors) and one or more tangible, non-transitory memories capable of implementing digital or programmatic logic. In various aspects, for example, the one or more controllers are one or more of a general-purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various aspects, the control unit 14 can include a single board computer such as a Raspberry Pi. In various aspects, the control unit 14 controls, at least various parts of, and operation of various components of, the visual display system 100. For example, the control unit 14 can control various parameters of the display lights such as power to the display lights, brightness of the display lights, and/or a color of the display lights. The control unit 14 can cause the display lights to be operated in a pattern, such as a sequential light pattern. The control unit 14 can cause the display lights to be operated in harmony with music or other audio signals. The control unit 14 can be disposed on-site, adjacent the support structure 10. The control unit 14 can be configured to manage any connected skin/display, regardless of the layout of the lights on the sub-panels/displays.

In various aspects, the control unit 14 can include a communication unit 15 for communicating with a remote electronic component (e.g., a personal device, a smartphone, a tablet, a computer, a computer network, etc.). The control unit 14 can be configured to receive and/or implement display light program files for controlling the display lights 32 via the communication unit 15. In various aspects, the communication unit 15 can comprise any suitable communications interface. The communication unit 15 enables data to be transferred to the control unit 14. The communication unit 15, for example, can include a modem, a network interface (e.g., an Ethernet card), a communications port, a Personal Computer Memory Card International Association (PCMCIA) slot and card or the like. Data transferred via the communication unit 15 can be in the form of electronic, electromagnetic, or optical signals, or other signals capable of being transmitted and/or received by the communication unit 15. These signals are provided to the control unit 14 via a communications path or a network 16. The network 16 can be configured to transmit the signals and can be implemented using a wire, a cable, a fiber optic line, a telephone line, a cellular link, a radio frequency (RF) link, a wireless link or other communication channel. In such manner, the network 16 can connect the control unit 14 with a remote electronic component, via the communication unit 15.

Computer programs (also referred to as computer control logic) can be stored in main memory and/or secondary memory of the control unit 14. Computer programs can also be received via the communication unit 15. Such computer programs, when executed, enable the control unit 14 to perform the features as discussed herein. In particular, the computer programs, when executed, enable the processor of the control unit 14 to perform the features of various aspects. Accordingly, such computer programs represent controllers of the control unit 14.

In various aspects, one or more light program files for controlling the display lights 32 are stored locally on the control unit 14. Each light program file can be for a different display. In various aspects, a light program file can be an FSEQ file generated by a sequence editor such as XLIGHTS® or other light sequencing and/or video mixing software. The light program files can also be received via the communication unit 15.

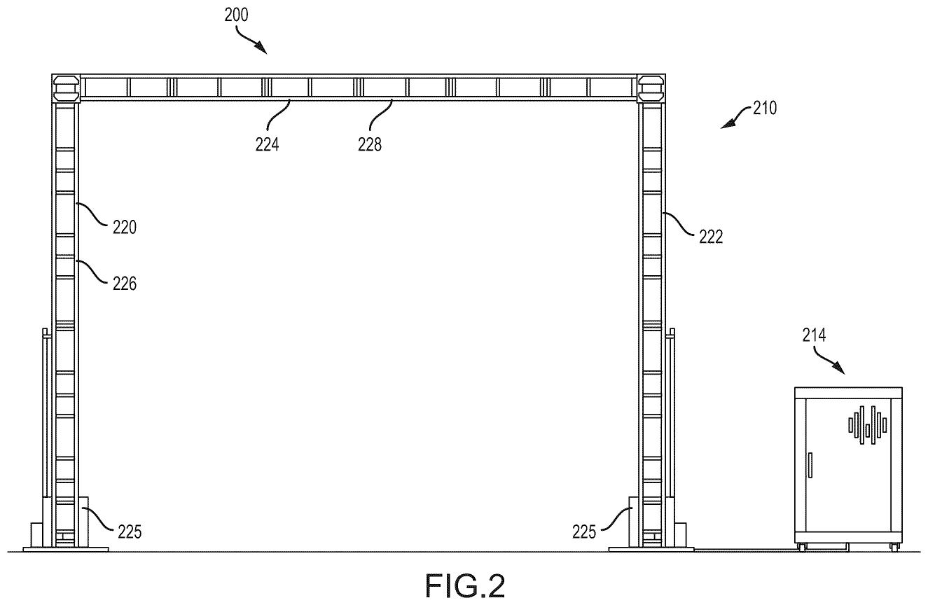

FIG. 2 is a front view of a support structure 210 and a control unit 214 for a visual display system 200, in accordance with various aspects. The support structure 10 and the control unit 14 of FIG. 1 can be similar to the support structure 210 and the control unit 214, respectively, in accordance with various aspects. The display panel and the mounting structure for the visual display system 200 is omitted in FIG. 2 for clarity purposes, though it should be understood that when in the installed position the display panel can cover some or all of the support structure 210 when viewed from the front.

In various aspects, the support structure 210 forms an arch. The support structure can include a first upright support 220, a second upright support 222 spaced apart from the first upright support 220, and a horizontal support 224 extending between and to the first upright support 220 and the second upright support 222. The horizontal support 224 can extend between and to a first end (e.g., an upper end) of the first upright support 220 and a first end (e.g., an upper end) of the second upright support 222. Although illustrated as a generally rectangular structure, the support structure 210 can be formed into any suitable shape or size, for example arcuate, triangular, ovular, round, etc. In various aspects, the support structure 210 can be shaped and sized so that a person or a vehicle can walk or drive under and through the support structure 210.

In various aspects, although illustrated as having the first upright support 220, the second upright support 222, and the horizontal support 224, it is contemplated that the horizontal support 224 and/or the second upright support 222 can be omitted depending on the application (e.g., shape, size, location, etc.) for the visual display system. For example, the support structure 210 can include the first upright support 220 formed as a single tower.

In various aspects, the first upright support 220 can include one or more upright frame members 226. The first upright support 220 can be made of tubes of metal, metal alloy (e.g., aluminum alloy), plastic, or composite, depending on the desired rigidity and load capacity. The first upright support 220 can be formed as a truss structure. In various aspects, the horizontal support 224 can include one or more horizontal frame members 228. The horizontal support 224 can be similar to the first upright support 220, except that the horizontal support 224 is oriented horizontally instead of vertically.

The visual display system 200 can further include one or more weights 225 disposed at a bottom end of the support structure 210. The weights 225 can aide in supporting the support structure 210 from tipping over. The weights 225 can be made of any suitable heavy material, such as metal, a metal alloy, concrete, sand, etc.

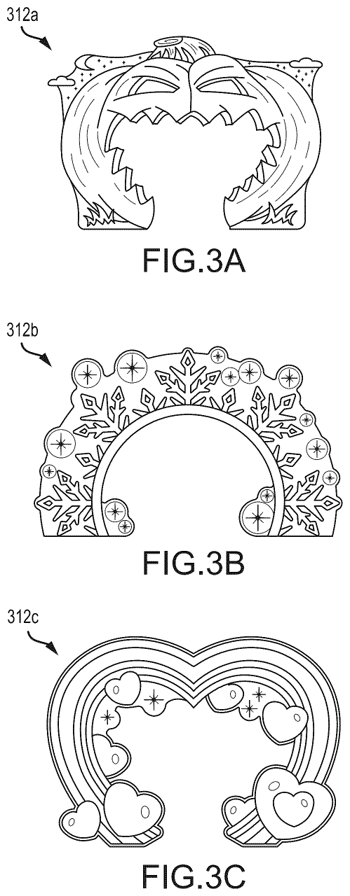

FIG. 3A is an example display panel 312a comprising a jack-o-lantern. The display panel 312a can be particularly useful for the fall holiday season or events that are fall themed. The display panel 312a can be shaped as a jack-o-lantern in various examples. The display panel 312a can have a design (a jack-o-lantern design in the illustrated example) on the front surface thereof. The display panel 312a can include a medium on the front surface thereof that visually depicts a jack-o-lantern (e.g., ink, paint, stickers, etc.). The display panel 312a can be formed into an arch shape.

FIG. 3B is an example display panel 312b comprising a snowflake. The display panel 312b can be particularly useful for the winter holiday season or events that are winter themed. The display panel 312b can be shaped as a snowflake in various examples. The display panel 312b can have a design (a snowflake design in the illustrated example) on the front surface thereof. The display panel 312b can include a medium on the front surface thereof that visually depicts a snowflake (e.g., ink, paint, stickers, etc.). The display panel 312b can be formed into an arch shape.

FIG. 3C is an example display panel 312c comprising a heart. The display panel 312c can be particularly useful for the Valentine's Day holiday and/or for other seasons or events that are love themed. The display panel 312c can be shaped as a heart in various examples. The display panel 312a can have a design (a heart design in the illustrated example) on the front surface thereof. The display panel 312b can include a medium on the front surface thereof that visually depicts a heart (e.g., ink, paint, stickers, etc.). The display panel 312c can be formed into an arch shape. Each of the display panels 312 shown in FIG. 3A through FIG. 3C can be interchangeably mounted to a common mounting structure as described herein.

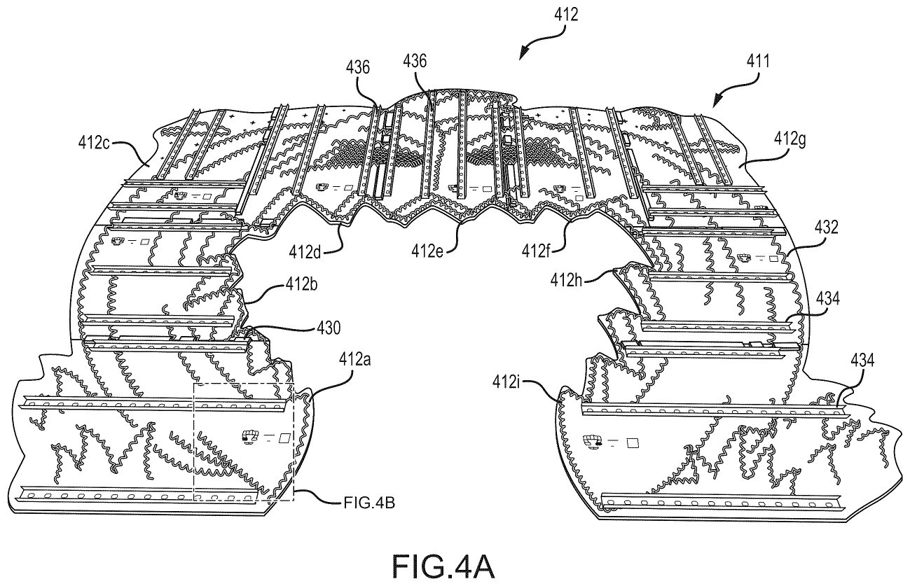

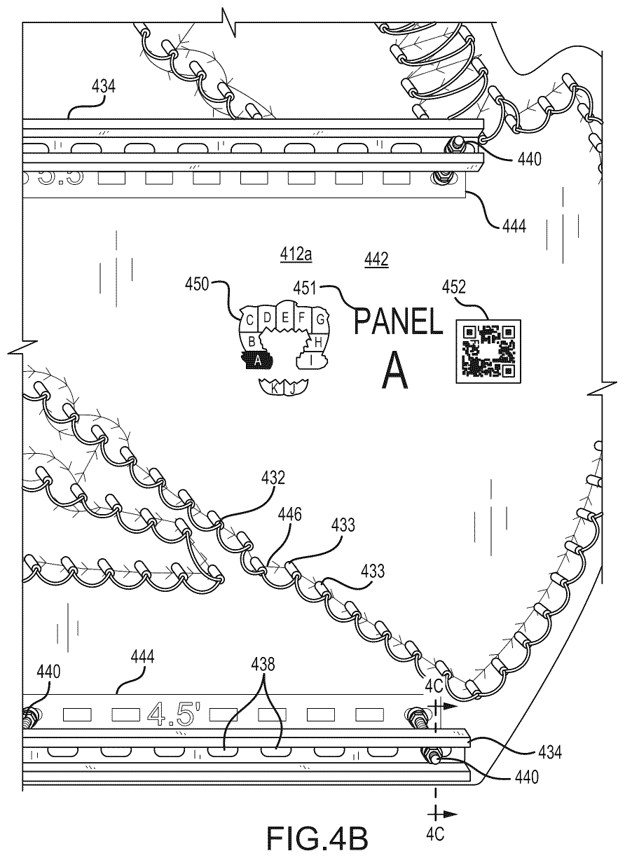

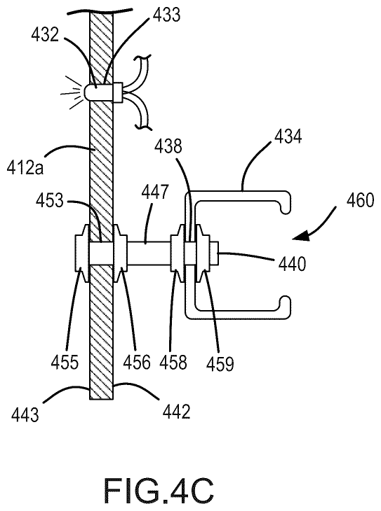

FIG. 4A is a rear view of an example display panel 412. In various aspects, the display panel 412 is similar to the display panel 312a—i.e., the display panel comprises a jack-o-lantern theme. However, the display panel 412 can be shaped and decorated to any suitable theme in various aspects.

In various aspects, the display panel 412 can include a plurality of sub-panels (e.g., sub-panel 412a, sub-panel 412b, sub-panel 412c, sub-panel 412d, sub-panel 412e, sub-panel 412f, sub-panel 412g, sub-panel 412h, and sub-panel 412i) coupled together to form the display panel 412. Each sub-panel can be made of a corrugated material, such as a corrugated plastic panel made of a polymer of plastic (e.g., polyvinyl chloride). In various aspects, each sub-panel can be made of a 10 mm corrugated plastic panel. In various aspects, the sub-panels can be made of a metal, a metal alloy (e.g., aluminum alloy), a wood substrate, a plastic substrate, or a composite material.

In various aspects, a joining feature 430 can extend across the seems of the sub-panels to help secure the edges of the sub-panels with respect to one another. For example, a joining feature 430 can extend across a seem between the sub-panel 412a and the sub-panel 412b. In various aspects, the joining feature 430 can be a hook-and-loop type fastener. In various aspects, the joining feature 430 can be a zip-tie fastener. This can help hold the edges of the sub-panel 412a and the sub-panel 412b aligned with one another. The joining feature 430 can secure the edges of the sub-panel 412a and the sub-panel 412b to abut with one another. The joining feature 430 can secure the front surfaces and/or the rear surfaces of the sub-panel 412a and the sub-panel 412b flush with one another.

In various aspects, particularly for lighted displays, the display panel 412 can include a plurality of decorative display lights 432 (e.g., light bulbs, LEDs, etc.). The lights 432 can be inserted through respective holes from the rear of the display panel 412 such that the light source is visible from a front side of the display panel 412 and the light housing and associated wiring is disposed at a rear side of the display panel 412. The lights 432 can include strands of lights. The lights 432 can be LED lights. The lights 432 can be operated to vary in brightness or color. The lights 432 can be operated in various patterns and/or in harmony with music or other audio signals. For example, the lights 432 can be in electronic communication with a controller (e.g., see control unit 14 of FIG. 1 or control unit 214 of FIG. 2).

In various aspects, a mounting structure 411 can be coupled to the display panel 412 for securing the display panel 412 to a support structure (e.g., see the support structure 10 of FIG. 1 and the support structure 210 of FIG. 2). The mounting structure 411 generally includes one or more horizontal support members 434 and/or vertical support members 436, depending on the orientation of the support structure to which the mounting structure 411 is being attached.

FIG. 4B is an enlarged view of a portion of the sub-panel 412a of FIG. 4A. In various aspects, the horizontal support members 434 are ridged beams. The horizontal support members 434 can be made of a metal, a metal alloy, a plastic material, or a composite material. The horizontal support member 434 can include a plurality of apertures for receiving a respective fastener 440 therethrough for securing the sub-panel 412a to the horizontal support member 434. The vertical support members 436 can be similar to the horizontal support members 434.

In various aspects, the horizontal support member 434 is formed as a u-shaped channel. In various aspects, the horizontal support member 434 is formed as, similar to, or representative of, for example, a UNISTRUT® brand rail member. A UNISTRUT® brand rail member can be a standardized formed structural system used in the construction and electrical industries for light structural support, often for supporting wiring, plumbing, or mechanical components such as air conditioning or ventilation systems. The horizontal support member 434 can be formed from sheet metal folded over into an open channel shape with inwards curving lips to provide additional stiffness and as a location to mount interconnecting components. The horizontal support member 434 can have holes in the base to facilitate interconnection or fastening the horizontal support member 434 to underlying building structures. The horizontal support member 434 can be a channel having a base portion and upstanding legs. The legs can have inwardly oriented lips, when viewed in cross-section, for example as illustrated in FIG. 4C.

In various aspects, the rear surface 442 of the sub-panel 412a can include a plurality of labels or markings to assist with assembling the system. A first set of labels 444 can be disposed on the rear surface 442 for illustrating or marking where the horizontal support members 434 are installed to the sub-panel 412a (i.e., a layout of a location for installing the horizontal support members 434 to the display panel 412). The first set of labels 444 can be formed as an outline of the horizontal support members 434. The first set of labels 444 can include information such as the length of the horizontal support member 434 at each location where a horizontal support member is to be installed. This can assist an installer to know where each of the parts are installed onto the sub-panel 412a. A second set of labels 446 can be disposed on the rear surface 442 for illustrating or marking where the lights 432 are installed to the sub-panel 412a (i.e., a layout of a location for installing the lights 432 to the display panel 412). The second set of labels 446 can include information such as the direction the lights 432 are installed. The second set of labels 446 can extend along a plurality of apertures 433 (also referred to herein as light apertures) disposed in the sub-panel 412a for receiving each of the light sources in the strand of lights 432. This can assist an installer to know where each of the strands of lights 432 are installed onto the sub-panel 412a.

Additional labels, such as label 450, can include an outline of the display panel with the relative location of the present sub-panel 412a with respect to the other sub-panels that make up the display panel (i.e., a layout of a location of a sub-panel of the display panel 412 with respect to other sub-panels of the display panel 412). Additional labels, such as label 451, can include a label for the panel (e.g., “Panel A,” Panel B,” etc.). Additional labels, such as label 452, can include a barcode (e.g., a QR code) that can be scanned by a digital device, such as a smartphone, to direct the installer to a website with additional information about the display panel, such as assembly instructions.

FIG. 4C is a section view of the connection between the sub-panel 412a of FIG. 4B installed on the horizontal support member 434. In various aspects, each fastener 440 extends between and to the sub-panel 412a and the horizontal support member 434. In various aspects, each fastener 440 extends horizontally between and to the sub-panel 412a and the horizontal support member 434. Each horizontal support member 434 can include a plurality of fasteners 440 whereby the sub-panel 412a is coupled to the horizontal support member 434. The fastener 440 can include a first pair of nut fasteners (e.g., a nut fastener 455 and a nut fastener 456) for securing the sub-panel 412a to the fastener 440. The nut fastener 455 can be disposed at a first surface (e.g., a front surface) of the sub-panel 412a and the nut fastener 456 can be disposed at an opposing second surface (e.g., a rear surface) of the sub-panel 412a. The fastener 440 includes a threaded rod 447 onto which the nut fasteners 455, 456 are threadingly coupled. In various aspects, the nut fastener 455 is coupled to the threaded rod 447 after the sub-panel 412a is installed. With the nut fastener 455 removed, the sub-panel 412a can be quickly and easily inserted over the end of the threaded rod 447 for quick installation of the sub-panel 412a. The sub-panel 412a includes a plurality of apertures 453, each of which is sized and configured to receive a respective threaded rod 447 for securing the sub-panel 412a in the installed position. The threaded rod 447 can be inserted through the respective aperture 453 disposed in the sub-panel 412a from the rear surface 442 of the sub-panel 412a. The threaded rod 447 can extend from the rear surface 442 past the front surface 443 of the sub-panel 412a so as to be accessible for tightening the nut fastener 455 on the end thereof.

The fastener 440 can include a second pair of nut fasteners (e.g., a nut fastener 458 and a nut fastener 459) for securing the sub-panel 412a to the fastener 440. The nut fastener 458 can be disposed at a first surface (e.g., a front surface) of the horizontal support member 434 and the nut fastener 459 can be disposed at an opposing second surface (e.g., a rear surface) of the horizontal support member 434. The aperture 438 through which the threaded rod 447 extends can be located between the nut fastener 458 and the nut fastener 459. In various aspects, the nut fastener 459 can be replaced with a permanent flange (e.g., a bolt head).

The nut fastener 456 can be spaced apart from the nut fastener 458 such that a length of the threaded rod 447 extends therebetween. For example, the length of the threaded rod extending between the nut fastener 456 and the nut fastener 458 can be at least a quart inch in various aspects, between a quart inch and three inches in various aspects, or between a half inch and three inches in various aspects. The length of this threaded rod 447 can be configured to receive a rear cover panel as described herein in greater detail.

The aperture 433 is configured for receiving a respective one of the plurality of lights 432 from the rear surface 442 of the sub-panel 412a (e.g., so that the wiring is hidden behind the sub-panel 412a). In the installed position, each one of the plurality of lights 432 can be viewable from a front surface 443 of the sub-panel 412a.

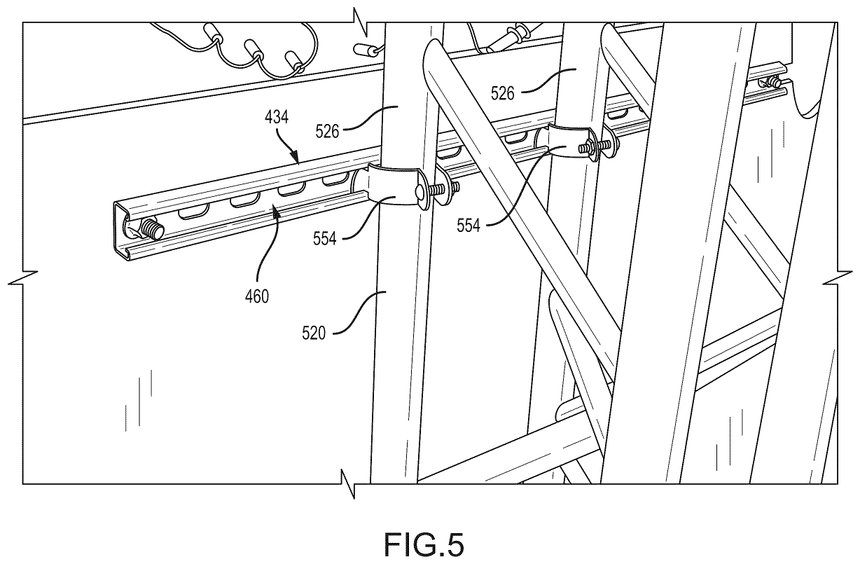

An elongated opening 460 in the horizontal support member 434 can face directly away from the sub-panel 412a. The elongated opening 460 can accommodate hardware for attaching the horizontal support member 434 to a support member as described herein in greater detail (e.g., see FIG. 5).

FIG. 5 is a rear perspective view of the horizontal support member 434 attached to an upright support 520 having a plurality of upright frame members 526. The horizontal support member 434 can be secured to each upright frame member 526 via a bracket 554. In various aspects, the bracket 554 can be a clamp. The bracket 554 can be received into the elongated opening 460 for securing the horizontal support member 434 to the upright frame member 526. In various aspects, the bracket 554 includes a first piece at a first side of the upright frame member 526 and a second piece at a second side of the upright frame member 526 that are coupled together with a fastener. The horizontal support member 434 can be in direct contact with the upright support 520 when in the installed position. The upright support 520 can include a first upright frame member 526 and a second upright frame member 526. The horizontal support member 434 can extend between and to the first upright frame member 526 and the second upright frame member 526.

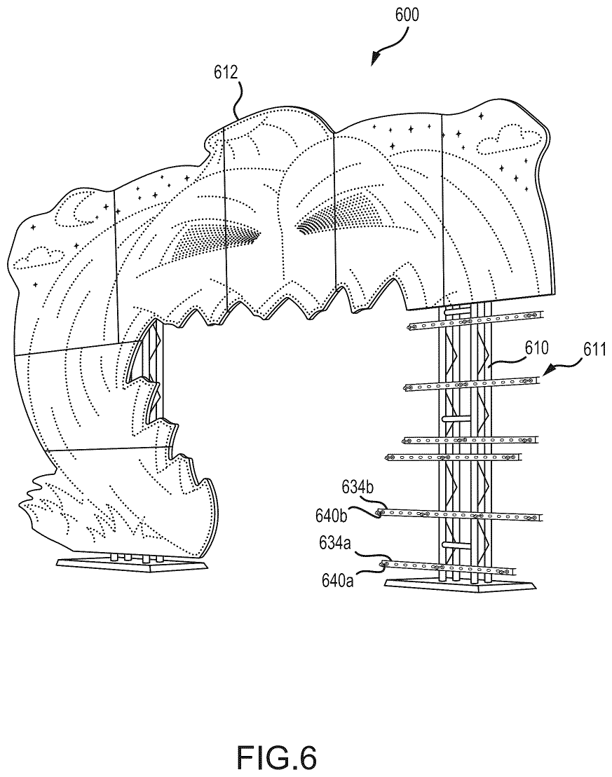

FIG. 6 is a perspective view of a visual display system 600 with some of the sub-panels of the display panel 612 removed, for example to exchange them with sub-panels having a different theme. Accordingly, the theme of the visual display system 600 can be easily adjusted by swapping out panels using a common support structure 610 and mounting structure 611. Stated differently, the theme of the visual display system 600 can be easily adjusted by swapping out panels without removal/detachment of the mounting structure 611 from the support structure 610.

In various aspects, the mounting structure 611 includes a first horizontal support member 634a and a second horizontal support member 634b. A first fastener 640a can extend from the first horizontal support member 634a and a second fastener 640b can extend from the second horizontal support member 634b. The display panel 612 is configured to extend between and to the first fastener 640a and the second fastener 640b so as to be supported by the first horizontal support member 634a and the second horizontal support member 634b.

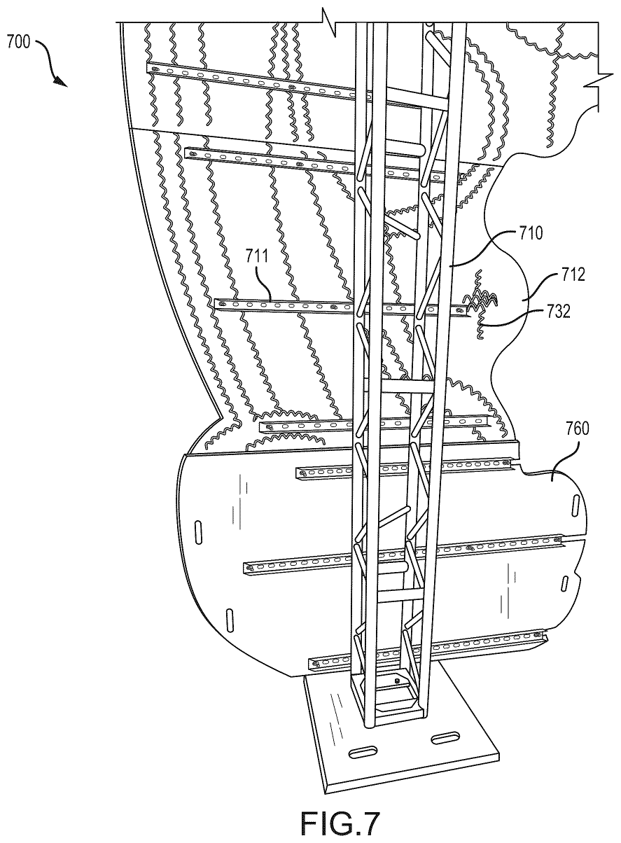

FIG. 7 is a rear view of a portion of a visual display system 700 having a rear cover panel 760 in an installed position. The visual display system 700 can be similar to the visual display systems described with respect to FIG. 1 through FIG. 6, except that the visual display system 700 further includes the rear cover panel 760. The visual display system 700 generally includes a support structure 710, a mounting structure 711, and a display panel 712. The rear cover panel 760 can protect the rear of the display panel 712 and the lights 732 and associated wiring. The rear cover panel 760 can improve the aesthetic of the visual display system 700. The rear cover panel 760 can be opaque so as to stop any residual light from the lights 732 from projecting rearward.

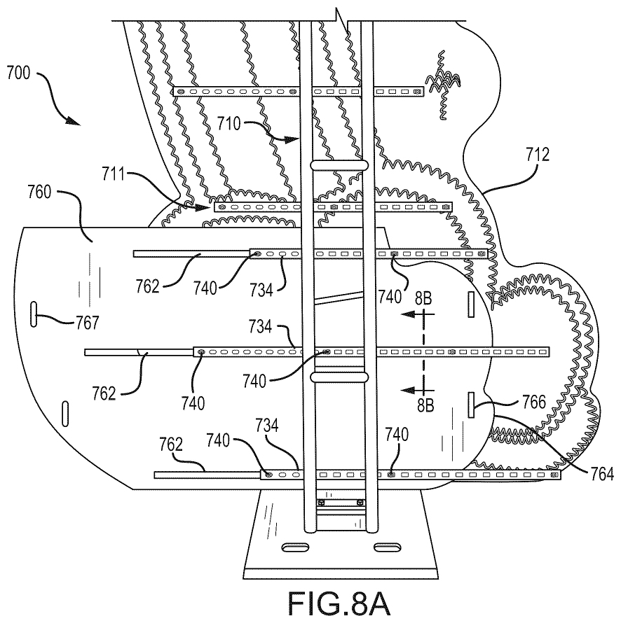

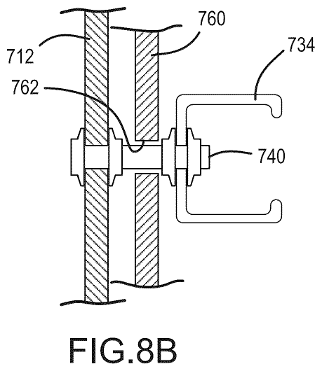

FIG. 8A is a rear view of a portion of the visual display system 700 showing the rear cover panel 760 being installed. FIG. 8B is a section view of the rear cover panel 760 of FIG. 8A. With combined reference to FIG. 8A and FIG. 8B, the rear cover panel 760 can be disposed between the rear surface of the display panel 712 and the horizontal support member 734. The rear cover panel 760 can include a plurality of elongated slots 762 configured to accommodate the fasteners 740 used for connecting the display panel 712 to the horizontal support members 734. Stated differently, the rear cover panel 760 can be moved (e.g., slid) over the fasteners 740 when installing the rear cover panel 760. The elongated slots 762 can extend from an edge 764 of the rear cover panel 760 whereby the fasteners 740 enter into the elongated slots 762. The rear cover panel 760 can be moved horizontally, parallel to the horizontal support members 734, when moving the rear cover panel 760 into the installed position such that the elongated slots 762 receive the fasteners 740 extending from the horizontal support members 734.

The rear cover panel 760 can include one or more handles 766 for pulling the rear cover panel 760 into the installed position. The handles 766 can be formed as apertures disposed in the rear cover panel 760 in various aspects. The rear cover panel 760 can include one or more handles 767 for sliding the rear cover panel 760 from the installed position to a removed position (i.e., for removing the rear cover panel 760). The handles 767 can be formed as apertures disposed in the rear cover panel 760 in various aspects. The handles 766 and the handles 767 can be disposed at opposite ends of the rear cover panel 760.

With particular focus on FIG. 8B, in the installed position, the display panel 712 is configured to be spaced apart from the horizontal support member 734 so that the rear cover panel 760 can be moved over the fasteners 740. The fastener 740 extends through the elongated slot 762 disposed in the rear cover panel 760.

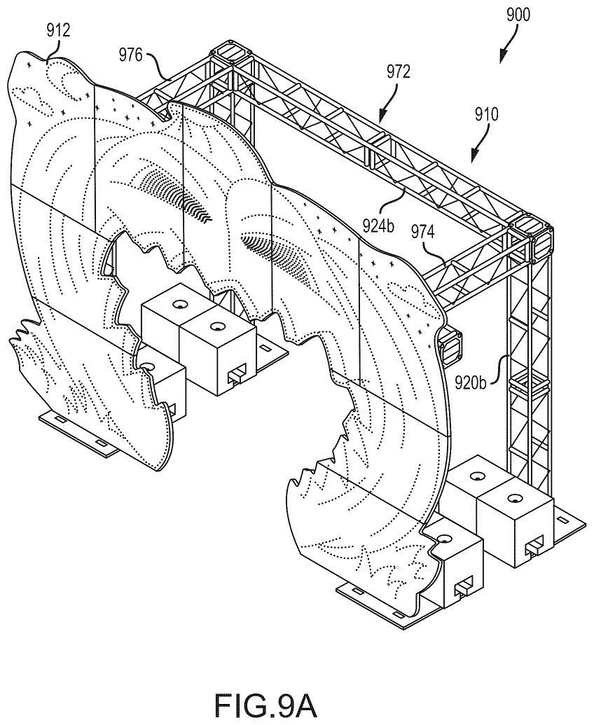

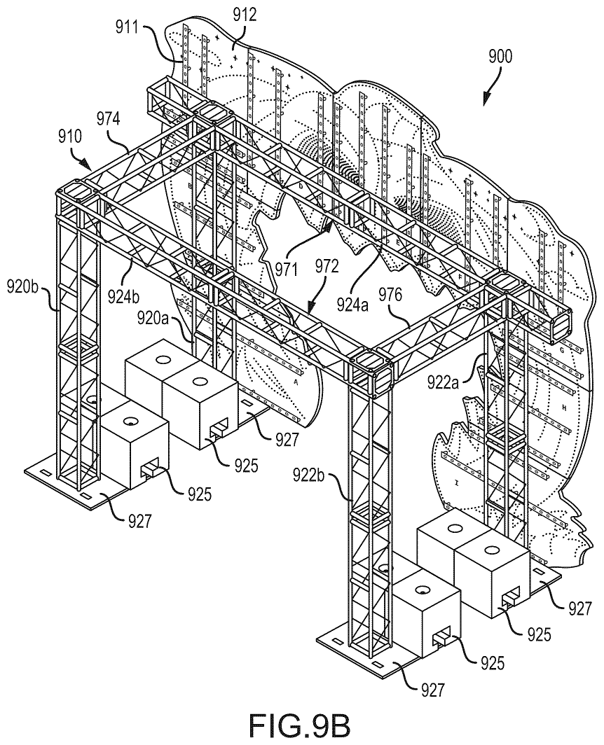

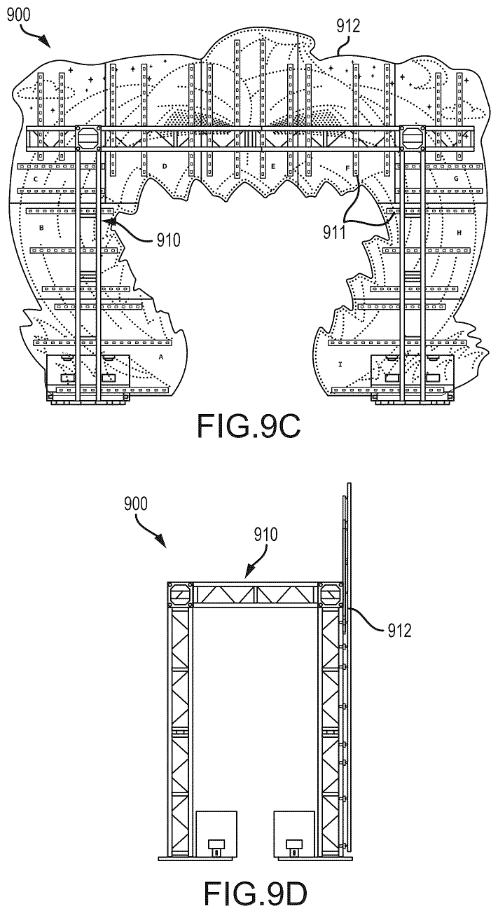

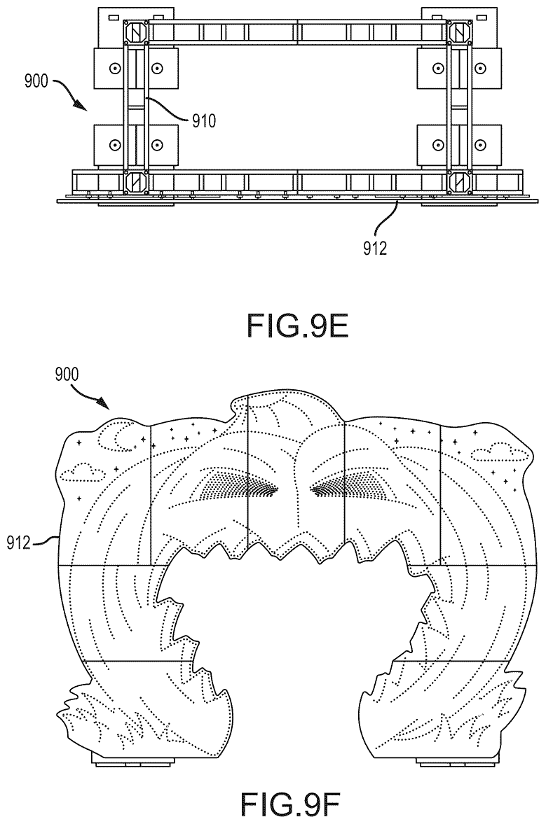

FIG. 9A through FIG. 9F are various views of a visual display system 900 having a tandem support structure, in accordance with various examples. The visual display system 900 can be similar to the visual display systems described with respect to FIG. 1 through FIG. 8B, except that the support structure 910 is a tandem support structure. The visual display system 900 generally includes a support structure 910 and a display panel 912 mounted to the support structure via a mounting structure 911. With particular focus on FIG. 9B, the tandem support structure generally includes a first arch 971, a second arch 972, and one or more horizontal supports (e.g., a first horizontal support 974 and a second horizontal support 976) extending between and to the first arch 971 and the second arch 972. The first horizontal support 974 and the second horizontal support 976 can be located at an upper end of the first and second arches 971, 972. The first arch 971 can include a first upright support 920a, a second upright support 922a spaced apart from the first upright support 920a, and a first horizontal support 924a extending between and to the first upright support 920a and the second upright support 922a. The second arch 972 can include a third upright support 920b, a fourth upright support 922b spaced apart from the third upright support 920b, and a second horizontal support 924b extending between and to the third upright support 920b and the fourth upright support 922ba.

The horizontal support 924a can extend between and to a first end (e.g., an upper end) of the first upright support 920a and a first end (e.g., an upper end) of the second upright support 922a. Similarly, the horizontal support 924b can extend between and to a first end (e.g., an upper end) of the third upright support 920b and a first end (e.g., an upper end) of the fourth upright support 922b. Although illustrated as a generally rectangular structure, the support structure 910 can be formed into any suitable shape or size, for example arcuate, triangular, ovular, round, etc. In various aspects, the support structure 910 can be shaped and sized so that a person or a vehicle can walk or drive under and through the support structure 910.

The support structure 910 can be mounted to one or more platforms 927 located at a bottom end of the support structure 910. The platforms 927 can rest on a ground surface. The support structure 910 can be mounted to the platforms 927, for example using fasteners.

The visual display system 900 can further include one or more weights 925 disposed at a bottom end of the support structure 910. The weights 925 can be placed over the platforms 927. The weights 925 can aide in supporting the support structure 910 from tipping over. The weights 925 can be made of any suitable heavy material, such as metal, a metal alloy, concrete, sand, etc.

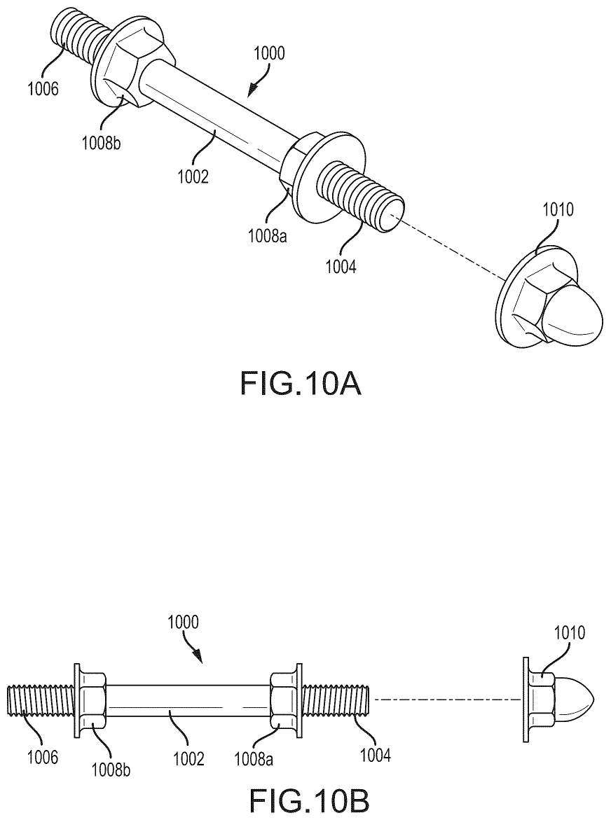

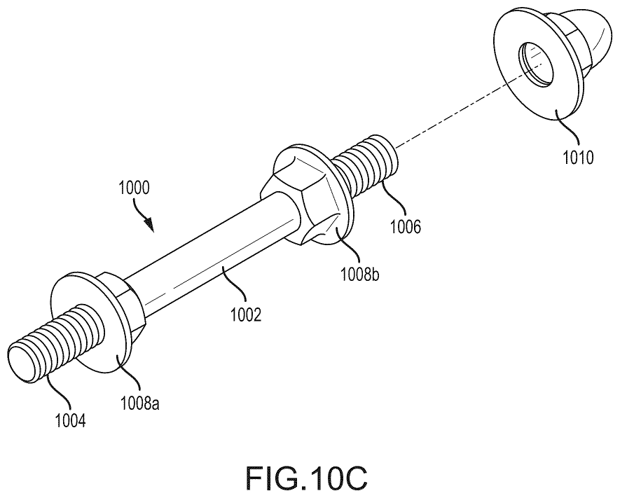

FIG. 10A, FIG. 10B, and FIG. 10C show example hardware or fasteners for mounting a display panel to a mounting structure. A display panel can be coupled to a mounting structure using a fastener, such as a double stud bolt 1000. A double stud bolt 1000 can include a central rod portion 1002, a first threaded end 1004, and a second threaded end 1006. The central rod portion 1002 can be formed as a smooth rod. The first flanged nut 1008a and the second flanged nut 1008b can each be made as a single piece or can be made as two separate pieces including one nut fastener and one washer. A nut fastener 1010 can be sized and configured to threadingly couple to the first threaded end 1004 for securing a display panel to the first threaded end 1004 of the double stud bolt 1000.

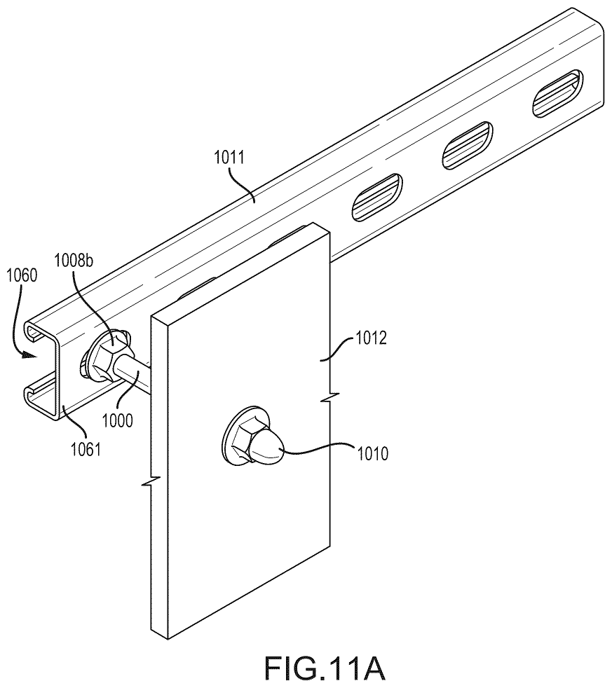

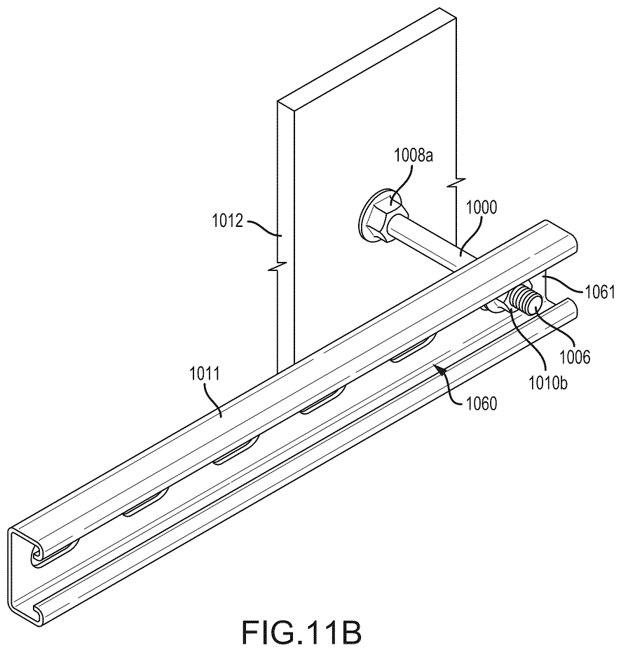

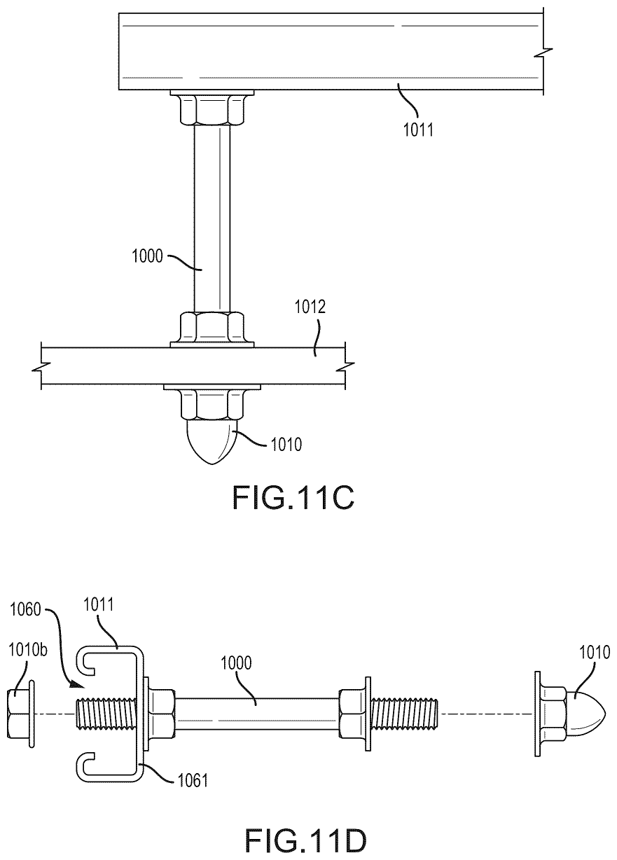

FIG. 11A is a front perspective view of a double stud bolt 1000 in an installed position. In a first configuration, an elongated opening 1060 in the mounting structure 1011 (e.g., a support member such as a Unistrut) can face away from the display panel 1012. The opening 1060 of the mounting structure 1011 can be located on a first side of a wall or base portion 1061 of the mounting structure 1011. The double stud bolt 1000 can extend from the base portion 1061 of the mounting structure 1011 in a direction opposite the opening 1060. The flanged nut 1008b can be located at a second side of the base portion 1061, opposite the base portion 1061 from the opening 1060. The display panel 1012 can be placed over the first threaded end of the double stud bolt 1000 and the nut fastener 1010 can be threadingly coupled to the first threaded end of the double stud bolt 1000 for securing the display panel 1012 to the mounting structure 1011.

FIG. 11B is a rear perspective view of the double stud bolt 1000 in the installed position. The flanged nut 1008a can be located at the second side of the base portion 1061. The flanged nut 1008a can be in contact with the display panel 1012. A second nut fastener 1010b can be tightened to the second threaded end 1006 for securing the double stud bolt 1000 to the mounting structure 1011. The second nut fastener 1010b can be located in the opening 1060 when in the installed position. The central rod portion 1002 can extend through the opening 1060.

FIG. 11C is a top view of the double stud bolt 1000 in the installed position.

FIG. 11D is a side view of the double stud bolt 1000 in the installed position. In FIG. 11D, the display panel is omitted and the nut fastener 1010 and the nut fastener 1010b are shown in assembly view.

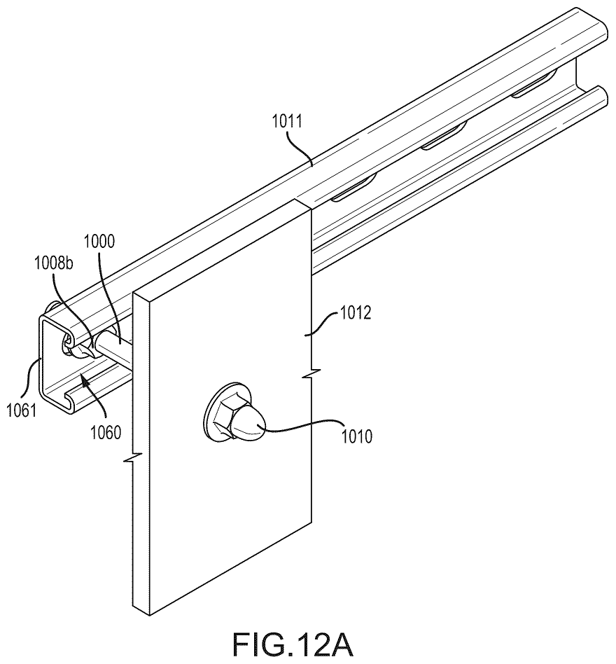

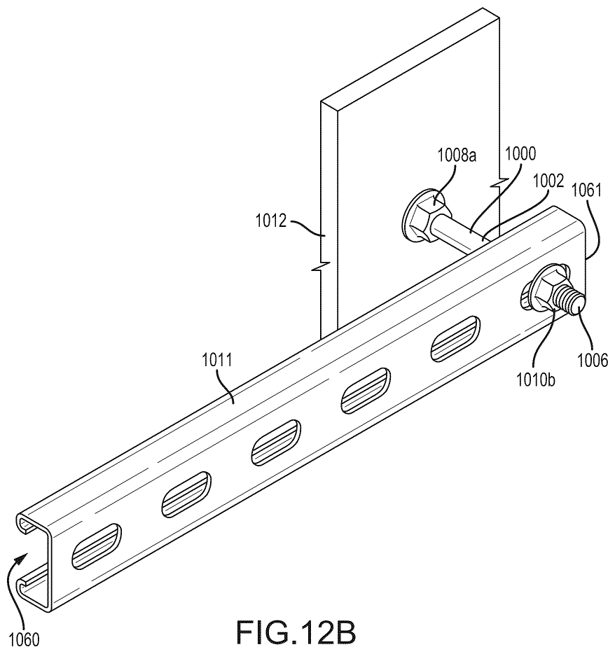

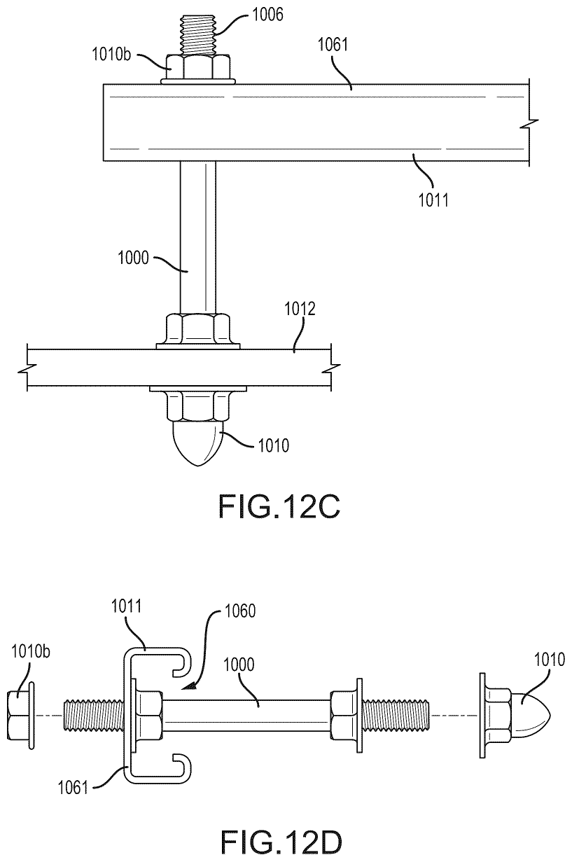

FIG. 12A is a front perspective view of the double stud bolt 1000 in an installed position in a second configuration with the elongated opening 1060 in the mounting structure 1011 facing toward the display panel 1012. In this regard, the double stud bolt 1000 can be oriented to extend from either side of the mounting structure 1011 depending on the desired orientation of the mounting structure 1011. In the second configuration, the double stud bolt 1000 can extend from the base portion 1061 of the mounting structure 1011 in a direction toward the opening 1060. The flanged nut 1008b can be located at the first side of the base portion 1061, within the opening 1060.

FIG. 12B is a rear perspective view of the double stud bolt 1000 in the installed position. The second nut fastener 1010b can be tightened to the second threaded end 1006 for securing the double stud bolt 1000 to the mounting structure 1011. The second nut fastener 1010b can be located at the second side of the base portion 1061 when in the installed position. The

FIG. 12C is a top view of the double stud bolt 1000 in the installed position.

FIG. 12D is a side view of the double stud bolt 1000 in the installed position. In FIG. 11D, the display panel is omitted and the nut fastener 1010 and the nut fastener 1010b are shown in assembly view.

Benefits and other advantages have been described herein with regard to specific examples. Furthermore, the connecting lines shown in the various figures contained herein are intended to represent example functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “various examples”, “various aspects”, “one aspect”, “an aspect”, “an example”, “an example aspect”, etc., indicate that the aspect/example described may include a particular feature, structure, or characteristic, but every aspect/example may not necessarily include the particular feature, structure, or characteristic. Moreover, such phrases are not necessarily referring to the same aspect/example. Further, when a particular feature, structure, or characteristic is described in connection with an aspect/example, it is submitted that it is within the knowledge of one skilled in the art to affect such feature, structure, or characteristic in connection with other aspects/examples whether or not explicitly described. After reading the description, it will be apparent to one skilled in the relevant art(s) how to implement the disclosure in alternative examples.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A visual display arrangement, comprising:
a support structure including a first upright frame member;
a mounting structure configured to be mounted to the support structure and including a first horizontal support member configured to be mounted to the first upright frame member;
a plurality of fasteners configured to extend horizontally from the first horizontal support member; and
a display panel configured to be removably mounted to the support structure via the plurality of fasteners, the display panel includes a plurality of fastener apertures configured to receive the plurality of fasteners for removably coupling the display panel to the support structure.

2. The visual display arrangement of claim 1, wherein the support structure further includes a second upright frame member, and the first horizontal support member extends between and to the first upright frame member and the second upright frame member.

3. The visual display arrangement of claim 2, wherein the support structure is formed as one of a tower or an arch.

4. The visual display arrangement of claim 1, wherein the first horizontal support member includes a plurality of apertures each configured to receive a respective one of the plurality of fasteners.

5. The visual display arrangement of claim 1, wherein the mounting structure further includes a second horizontal support member, the plurality of fasteners includes a first fastener configured to extend from the first horizontal support member and a second fastener configured to extend from the second horizontal support member, and the display panel is configured to extend between and to the first fastener and the second fastener so as to be supported by the first horizontal support member and the second horizontal support member.

6. The visual display arrangement of claim 1, wherein the plurality of fasteners includes a threaded rod, a first pair of nut fasteners configured to secure the threaded rod to the first horizontal support member, and a second pair of nut fasteners configured to secure the display panel to the threaded rod.

7. The visual display arrangement of claim 1, further comprising a plurality of lights, wherein the display panel comprises a plurality of light apertures configured to receive the plurality of lights.

8. The visual display arrangement of claim 7, further comprising a controller configured to be disposed adjacent the support structure and configured to operate the plurality of lights by adjusting at least one of a color or a brightness of each light of the plurality of lights, and the controller includes a storage configured to store a light display file for operating the plurality of lights.

9. The visual display arrangement of claim 1, wherein a rear surface of the display panel includes a label identifying at least one of:
a layout of a location of a sub-panel of the display panel with respect to other sub-panels of the display panel;
a layout of a location for installing a plurality of lights to the display panel; and
a layout of a location for installing the first horizontal support member to the display panel.

10. The visual display arrangement of claim 1, wherein the display panel includes a plurality of sub-panels each individually removable from the support structure.

11. The visual display arrangement of claim 1, further comprising a rear cover panel configured to be disposed between a rear surface of the display panel and the first horizontal support member so as to cover the rear surface.

12. The visual display arrangement of claim 11, wherein, in an installed position, the display panel is configured to be spaced apart from the first horizontal support member so that the rear cover panel can be moved over at least one fastener of the plurality of fasteners, wherein the at least one fastener extends through a slot disposed in the rear cover panel.

13. The visual display arrangement of claim 1, wherein the support structure further includes:
a second upright frame member; and
a first horizontal frame member configured to be coupled between a first end of the first upright frame member and a first end of the second upright frame member, and the first horizontal support member is configured to be coupled to the first upright frame member at a location spaced apart from the first end of the first upright frame member.

14. The visual display arrangement of claim 1, further comprising a bracket for removably coupling the first horizontal support member to the first upright frame member.

15. A visual display arrangement, comprising:
a support structure;
a plurality of lights;
a display panel configured to be mounted to the support structure, the display panel includes a front surface having a design and a rear surface, the display panel includes a first plurality of apertures configured to receive a plurality of fasteners from the rear surface for removably coupling the display panel to the support structure, the display panel includes a second plurality of apertures each configured for receiving a respective one of the plurality of lights from the rear surface of the display panel, and the design and the plurality of lights are configured to be viewable from the front surface of the display panel.

16. The visual display arrangement of claim 15, further comprising a mounting structure coupled between the support structure and the plurality of fasteners.

17. The visual display arrangement of claim 16, wherein the display panel is spaced apart from the mounting structure via the plurality of fasteners.

18. The visual display arrangement of claim 17, wherein the mounting structure is formed as a u-shaped channel.

19. The visual display arrangement of claim 15, further comprising a rear cover panel including an elongated slot configured to receive the plurality of fasteners whereby the rear cover panel is secured to the support structure.

20. The visual display arrangement of claim 15, wherein the support structure includes:
a first arch including a first upright support, a second upright support spaced apart from the first upright support, and a first horizontal support extending between and to the first upright support and the second upright support;
a second arch including a third upright support, a fourth upright support spaced apart from the third upright support, and a second horizontal support extending between and to the third upright support and the fourth upright support; and
at least one horizontal support extending between and to the first arch and the second arch.
